(19) United States
(12) Patent Application Publication
(10) Pub. No.: US 2007/0299923 A1
(43) Pub. Date: Dec. 27, 2007

(54) METHODS AND SYSTEMS FOR MANAGING MESSAGING

(76) Inventors: George J. Skelly, Carlisle, MA (US); Andrew Joseph Hachey, North Reading, MA (US)

Correspondence Address: STRATEGIC PATENTS P.C.., C/O PORTFOLIOIP, P.O. BOX 52050, MINNEAPOLIS, MN, 55402, US

(21) Appl. No.: 11/763,912

(22) Filed: Jun. 15, 2007

Related U.S. Application Data
(60) Provisional application No. 60/804,943, filed on Jun. 16, 2006.

(51) Int. Cl. G06F 15/16; G06F 15/173

(52) U.S. Cl. 709/206; 709/224

(57) ABSTRACT

Methods and systems for handling electronic mail provide an audit trail of recipient interactions with an electronic mail message. By tracking, for example, whether attachments were opened and which portions of the message have been displayed, a recipient of an electronic mail can preserve a record of what information the recipient has been potentially exposed to and what information has demonstrably not been seen by the recipient.

### RELATED APPLICATIONS

This application claims the benefit of U.S. App. No. 60/804,943 filed on Jun. 16, 2006, the entire contents of which are incorporated herein by reference.

### BACKGROUND OF THE INVENTION

With present e-mail technology, executives at major companies are exposed to enormous potential legal liability (and business/reputational risk), including potential criminal liability, as a direct result of being sent (or copied on) e-mails that they have not actually read (or read fully). From a legal evidentiary standpoint, the fact that a company's president, for example, is listed as having been copied on a e-mail is taken by federal and state prosecuting agencies (such as the Securities and Exchange Commission, U.S. Department of Justice, or state Attorneys General), and ultimately by juries, as establishing his or her knowledge and involvement in the matters mentioned in the e-mail (or its attachments). This same presumption of knowledge/involvement based on receipt of an e-mail can be made by a board of directors (or more senior executive at the company) in evaluating the executive's job performance. Thus, based on the presumption that executives have thoroughly reviewed the e-mails in question (and their attachments), executives are being charged with fraud due to e-mails that appear to link them to transactions carried out far down in a company's structure by lower level employees.

In many cases, the truth is completely to the contrary, and the executive had no knowledge of or involvement in the transaction(s) in question. Indeed, given the volume of e-mails that executives may receive, and the fact that many such e-mails will be reviewed in a cursory manner on a handheld device while the executive is traveling or in meetings, it is reasonable to assume that many e-mails that are opened by an executive will never be fully read by the executive. It is likely that, in many instances, an executive will only read the subject line of a e-mail or the first few words or lines of its content before closing (and perhaps deleting) the e-mail and moving on to the next one. This assumption gains even more validity with respect to e-mails that are lengthy, have multiple e-mails contained below them (so-called “e-mail chains”) and/or have attachments. Based on these assumptions, the executive may not have even seen (or at least focused on) the language in the e-mail (or in an attachment which may not even be accessible through a handheld device) as to which knowledge is imputed to the executive months or years later in the context of a regulatory investigation or criminal proceeding. Testimony by executives that they did not read the e-mail in question (or at least that part of an e-mail or its attachment that gives rise to the legal issue) is treated as a lie because the electronic “paper trail” showing that the executive opened the e-mail suggests that the executive fully reviewed the e-mail and its attachments. There is such a strong presumption from the documentary record that it is virtually irrefutable.

### SUMMARY

Methods and systems for handling electronic mail provide an audit trail of recipient interactions with an electronic mail message. By tracking, for example, whether attachments were opened and which portions of the message have been displayed, a recipient of an electronic mail can preserve a record of what information the recipient has been potentially exposed to and what information has demonstrably not been seen by the recipient.

### BRIEF DESCRIPTION OF THE DRAWINGS

The foregoing and other objects and advantages of the invention will be appreciated more fully from the following further description thereof, with reference to the accompanying drawings, wherein:

FIG. 1 shows a method for storing an audit trail for electronic mail.

### DESCRIPTION OF THE PREFERRED EMBODIMENT(S)

A method and apparatus for allowing recipient control over the amount of an e-mail or other electronic communication received and reviewed by the recipient and for tracking of such receipt and review.

A method and apparatus for allowing recipient control over significant aspects of incoming electronic communications (hereinafter designated as “e-mail” although not limited to that format), such as (1) the ability to choose the amount of text of an e-mail that will be received at the recipient's desktop computer (PC), (2) the ability to control how much more of the text of that e-mail will be received at the recipient's PC, on an iterative basis, as recipient review of the e-mail is ongoing, (3) the ability to indicate to the sender of the e-mail, via a reply e-mail function as to which the user can choose the text, that the e-mail was not reviewed, or was only partially reviewed, and (4) the ability to designate a partially reviewed e-mail for later review or for removal from the recipient's PC (with a recipient-controlled retrieval feature). Outside of the e-mail recipient's control, this method and apparatus would track and maintain a record of important aspects of the e-mail recipient's e-mail activity, including how much of each e-mail was viewed by the recipient, for how long each portion of each e-mail was “open” on the recipient's PC, the recipient's reply to the e-mail, and the designation of each e-mail for subsequent later review or removal from the PC. Additionally, this method and apparatus allows for the e-mail recipient to establish, via parameters such as sender, subject, or keyword sorting, that display of the list of unreviewed e-mails be in an hierarchical order of priority.

Companies and their executives need a method and apparatus that will serve to limit the exposure of innocent executives to liability (or business/reputational risk) based on having been copied on an e-mail. Presently, the meta-data of an e-mail system merely reflects that the e-mail was indeed received and opened, which exposes the executive and the company to the full liability of presumed knowledge by the executive of the complete contents of the e-mail and its attachments. The solution proposed by this invention should not only limit actual exposure of the executives (and companies by extension) caused by such e-mails, but may also be perceived by prosecutors, regulators, and boards of directors (or more senior executives within a company) as (a) legitimate, (b) honestly reflective of the subject's interaction with the e-mails and their attachments, and (c) a source and repository of accurate and unalterable business records (such as may be admissible as evidence in court). One primary benefit of the solution is expected to be that a presumption of knowledge, and therefore responsibility, based on the executive's contact with e-mails sent by others will no longer be available to plaintiffs and prosecutors (or skeptical boards of directors, customers, and members of the press).

Another substantial expected benefit of the proposed solution is likely to be a shift in the e-mail culture within major companies that will lead to fewer lengthy e-mails to executives. The executive's ability to generate an automated response indicating that the executive did not read much of the content of an e-mail should lead to a company culture in which e-mails sent to executives will be more focused, thoughtful and less frequent.

In embodiments, this method and apparatus is a software program (or a combination software program, firmware, and hardware device) that works behind and within a company's existing e-mail systems, including its handheld device message delivery system. From the perspective of the e-mail recipient, it has four primary components.

First, it stops an e-mail message from being fully delivered to the recipient's PC. Instead, it gives the recipient some information (or, at the user's option, a pre-assigned amount of e-mail text) that allows the recipient to choose whether to receive the content (or more of the content) of the e-mail at his or her PC. The user will be able to customize this initial information to include the typical “to”, “from”, date, time, and subject line information, as well as a variable, user-selectable, number of words or lines of the text of the e-mail message. An additional (optional) feature within this first component is the ability of the user to set hierarchical parameters such that the list of unreviewed e-mails are presented in order of hierarchical priority and/or categories. The categories into which e-mail may be sorted can be selected by the user or could be automatically suggested by the software based on analysis of e-mails that the recipient has opened or received.

Second, once the user has decided to open, or to review more of the e-mail message, only a pre-determined (user-selectable) number of words or lines of the text of the message would be displayed on the user's PC. At this point, the user would have the option to continue to review more of the message (by, e.g., mouse click or scroll wheel use). If the user determines to review more of the message, the next group of pre-determined number of words or lines will be displayed on the user's PC. This process would proceed on an iterative basis until the user has reviewed the complete e-mail.

Third, if the user decides not to review the entire e-mail (or any of the e-mail), the method and apparatus will allow the user to send an e-mail message response to the sender indicating that the e-mail was not reviewed or was only partially reviewed up to a point specified in the response. For example, the response could include all of the text of the portion of the e-mail that was reviewed along with a message indicating that the user only reviewed the e-mail up to that point. The text of the response e-mail could be a unique message typed by the user, it could be one of a number of standard responses preset by the user (and selected by the user at the point of response by the click of a mouse or use of a scroll wheel), or it could be a preselected default response. The default response (or one of the predetermined standard response options) could, for example, indicate that the user had only a brief opportunity to review the first few words of the message and regrettably is unable to respond at greater length. After sending the response message, the e-mail would be removed from the user's PC.

Fourth, in lieu of reviewing the message or responding to the sender, the user could (again with the click of a mouse or use of a scroll wheel) designate an e-mail for later review. The user would then have the ability to review some or all of the e-mail at a later point in time and respond to the sender as described above. Also, the user would have the ability to retrieve e-mails previously removed from the user's PC.

In embodiments, a component of the method and apparatus that would be outside of the individual user's control is the tracking and record-keeping feature. This method and apparatus would track and maintain a record of important aspects of the e-mail recipient's e-mail activity, including how much of each e-mail was viewed (or presented for viewing) by the recipient, whether attachments to the e-mail were opened, for how long each portion of each e-mail was “open” on the recipient's PC, the recipient's reply to the e-mail, and the designation of each e-mail for subsequent later review or removal from the PC. This information would be stored in a secure, auditable environment that would be searchable and retrievable. The availability of such a record would have the effect of accurately identifying what information the user actually reviewed (and for how long it was on the user's PC screen). This should eliminate incorrect presumptions that the user had knowledge of the entire contents of an e-mail message simply because the user opened the e-mail.

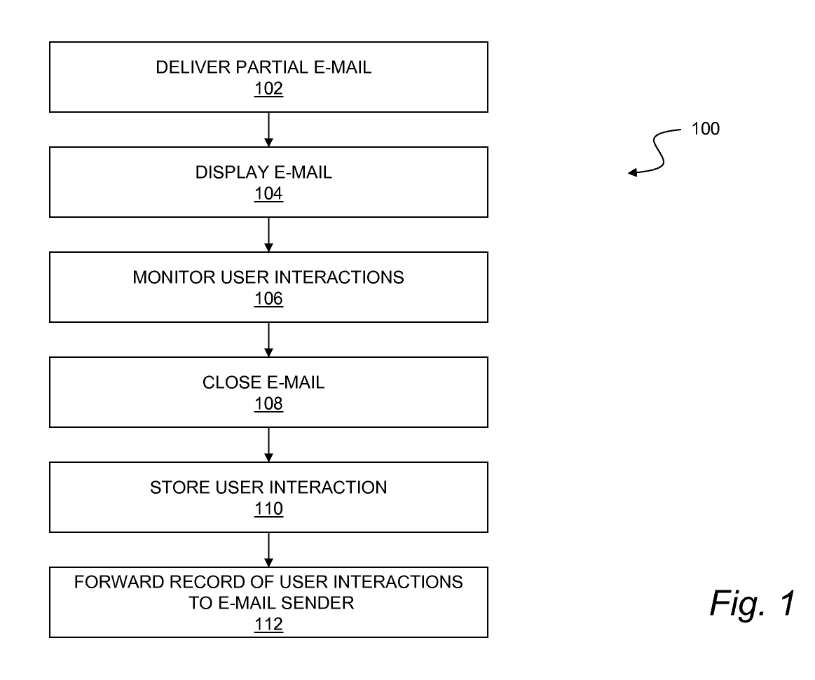

FIG. 1 shows a method embodying the features described above, which method may, for example, be embodied in a computer program product comprising computer executable code that, when executing on one or more computing devices, performs some or all of the steps described below.

The method 100 may begin by delivering a partial e-mail to a client device as shown in step 102. The partial e-mail may include, for example, header information such as the sender, recipient list, subject line, time of delivery and a portion of a text message or the like contained within the electronic mail. The e-mail may be displayed at a client device by a recipient, as shown in step 104. This may include, for example, a display of some or all of the partial e-mail described above. As shown in step 106, the client device may monitor user interactions with the e-mail. This may include, for example, opening or saving attachments to the e-mail, scrolling down to view additional text in an e-mail message, activating executable code within the e-mail, navigation to hyperlinks within the e-mail, downloading of external images or the like into the e-mail, review of metadata such as the date, subject, addressee information, and so forth. At some point either before or after a user has reviewed the entire e-mail, the user may close the e-mail as shown in step 108. As shown in step 110, the user interaction(s) with the e-mail may be stored as a record or audit trail for the message. This record may be stored, for example, on the client device or at a remote location. As shown in step 112, the record of user interactions may also be sent to the e-mail sender to provide information to the sender concerning how much of the e-mail was accessed by the recipient.

While the invention has been described in connection with certain preferred embodiments, it should be understood that other embodiments would be recognized by one of ordinary skill in the art, and all such variations and modifications are intended to fall within the scope of the inventive concepts disclosed herein.

What is claimed is:

1. A method comprising:
delivering at least a portion of an electronic mail message to a recipient at a client device;
displaying the portion of the electronic mail message on the client device;
tracking a user interaction with the electronic mail message, the user interaction including one or more of opening an attachment to the electronic mail message and displaying an additional portion of the electronic mail message for user review; and
storing a record of the user interaction when the electronic mail message is closed.

2. The method of claim 1 further comprising retrieving the record when the electronic mail message is subsequently opened and supplementing the record with one or more additional user interactions with the electronic mail message.

3. The method of claim 1 further comprising generating a message to a sender of the electronic mail message informing the sender of what user interaction occurred with the electronic mail message.

4. The method of claim 1 further comprising permanently deleting the electronic mail message from the client device, and storing the record of the user interaction at one or more of the client device and a remote location.
